(19) United States
(12) Patent Application Publication
(10) Pub. No.: US 2007/0262179 A1
(43) Pub. Date: Nov. 15, 2007

(54) POLYETHELENE HOPPER HAVING INTEGRATED WETTING COMPARTMENTS

(76) Inventors: Eric Larsen, Cortland, IL (US); George Bailey, Byron, IL (US)

Correspondence Address: BROUSE MCDOWELL LPA, 388 SOUTH MAIN STREET, SUITE 500, AKRON, OH, 44311, US

(21) Appl. No.: 11/740,411

(22) Filed: Apr. 26, 2007

Related U.S. Application Data
(60) Provisional application No. 60/745,647, filed on Apr. 26, 2006.

(51) Int. Cl. A01C 23/00

(52) U.S. Cl. 239/662; 239/667

(57) ABSTRACT

A spreader system may include a hopper formed substantially of plastic for use in holding solid agents and a conveyor system formed substantially of non-corrosive metal for use in conveying solid agents. The spreader system may also include a compartment formed integral with a wall of the hopper for use in holding liquid agents.

This application claims priority to U.S. Ser. No. 60/745,647, entitled POLYETHELENE HOPPER HAVING INTEGRATED WETTING COMPARTMENTS, filed Apr. 26, 2006, which is incorporated herein by reference.

### I. BACKGROUND OF THE INVENTION

A. Field of Invention

This invention pertains to the art of methods and apparatuses for spreader systems, and more specifically to a spreader system with a polyethelene hopper having one or more compartments formed integral within the walls of the hopper for use in holding a liquid agent.

B. Description of the Related Art

During harsh winter months, snow and ice accumulates on roads, driveways, parking lots and other such surfaces. When heavy snow and/or ice accumulate, these surfaces are often treated by scraping away the snow with a snow plow and then treating the surface with salt, sand or other material, including liquid materials, to provide traction and eliminate slippery conditions for motorists. It is also known to treat these surfaces prior to, and in anticipation of, such snow and ice. Conventional methods for treating snow and ice covered roadways employ the use of separate application equipment to dispense granular materials, such as salt/sand spreaders, or bulk liquid spray systems, such as skid mounted tank/sprayer systems or bulk storage tanker/trailer rigs fitted with spray booms. A conventional method for delivering both granular and liquid materials include the combination of a V-box spreader and a pre-wet system of liquid storage tanks mounted typically in a dump body or on the flatbed of a truck.

Such spreader systems known in the art, while suited for their intended purpose, still have disadvantages. First, most spreader systems are made of steel, which is heavy, and not always corrosion resistant. Second, the tanks used to store pre-wetting agents are bulky requiring additional space on the vehicle carrying the tanks as well as additional piping to carry the pre-wetting agents to the desired destination.

The present invention provides a polyethylene hopper which is lightweight and corrosion resistant and that may be used in conjunction with a stainless steel conveyor system. The present invention also includes the integration of one or more compartments into the walls of the hopper thereby eliminating the need for separate tanks.

### II. SUMMARY OF THE INVENTION

According to one embodiment of this invention, a spreader system may include: a hopper formed substantially of plastic for use in holding solid agents; a conveyor system formed substantially of non-corrosive metal for use in conveying solid agents; and, a compartment formed substantially of plastic and formed integral with one of the hopper walls for use in holding liquid agents.

According to another embodiment of this invention, a spreader system may include a conveyor system defining a frame with the hopper being attached to the conveyor system.

According to another embodiment of this invention, a spreader system may include a spinner system formed substantially of non-corrosive metal for use in distributing solid agents. The spinner system may be connected to the conveyor system.

According to yet another embodiment of this invention, a spreader system may include a liquid spray system for use in distributing liquid agents. The liquid spray system may receive liquid from the compartment.

According to another embodiment of this invention the compartment may extend beyond the outer surface of the wall.

According to another embodiment of this invention the hopper may have side walls angled to form a V-shape.

One advantage of this invention is that the spreader system is economical to manufacture.

Another advantage of this invention is that compartments formed integral with the hopper eliminates the need for separate wetting tanks.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a back view of a vehicle equipped with the spreader system of this invention.

FIG. 2 is an assembly side view of one embodiment of the present invention.

FIG. 3 is a partial assembly back view of the embodiment shown in FIG. 2.

FIG. 4 is a top view of the hopper.

FIG. 5 is a side view of the hopper shown in FIG. 4.

FIG. 6 is a front view of the hopper shown in FIG. 4.

FIG. 7 is a sectional view taken along the line 7-7 of FIG. 5.

FIG. 8 is a sectional view similar to that shown in FIG. 7 but showing another embodiment of this invention.

FIG. 9 is a schematic representation of a liquid spray system that may be used with this invention.

### IV. DETAILED DESCRIPTION OF THE INVENTION

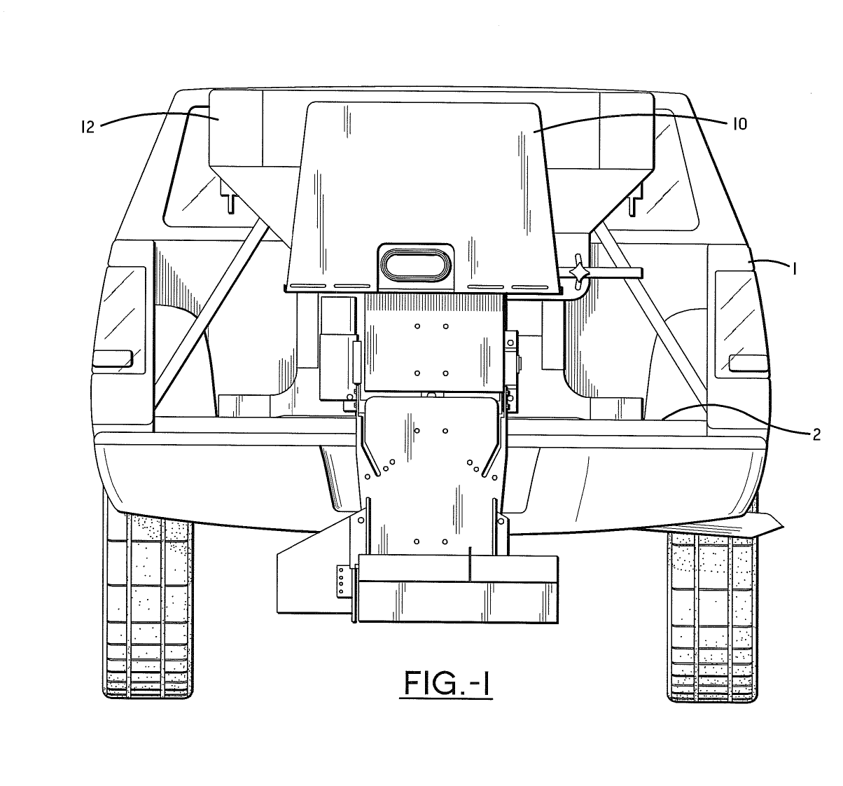

Referring now to the drawings wherein the showings are for purposes of illustrating embodiments of the invention only and not for purposes of limiting the same, FIG. 1 shows a spreader system 10 having a hopper 12 according to this invention. The spreader system 10 is positioned on a bed 2 within a truck 1. While the truck 1 shown is a conventional pick-up truck, it is to be understood that the spreader system 10 of this invention will work with any type of truck or other vehicle chosen with sound engineering judgment. In this way the spreader system 10 can be transported by the truck 1 to any desired roadway location where any desired material, such as salt or sand, or any liquid agent, can be distributed by the spreader system 10 onto the road surface. The positioning of the spreader system 10 within the truck 1 and the overall operation of the spreader system 10 in distributing or spreading materials onto a road surface are conventional and thus will not be described in detail.

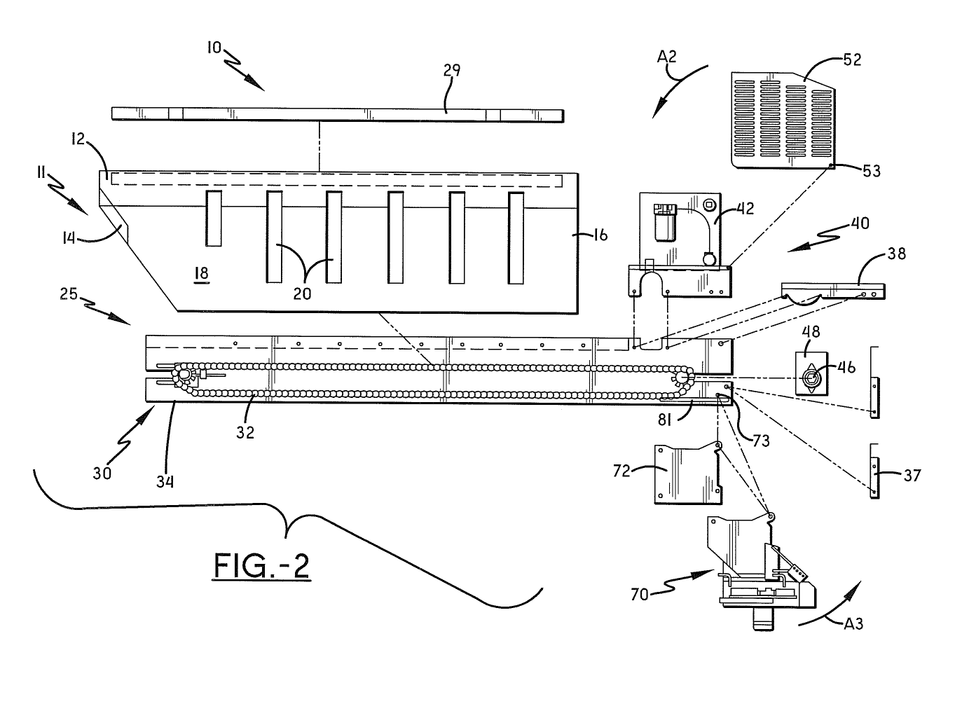

With reference now to FIG. 2, the spreader system 10 includes the hopper 12 which is used to hold the material, whether solid agents such as salt or sand or liquid agents such as brine, which is to be spread upon the road surface. The hopper 12 may also hold liquid agents that are combined with the solid agents prior to spreading. The spreader system 10 may also include a conveyor system 30 which transports or conveys the solid agent toward an end of the spreader system 10 where it can be distributed. More specifically, the conveyor system 30 includes a trough 34 (which may act as a frame for the conveyor system 30) and a conveyor chain and/or belt 32 that is operatively connected to and operates within the trough 34. A power unit 40 provides power to operate the conveyor chain and/or belt 32. The conveyor chain and/or belt 32 may transport the solid material to a spinner system 70 that is attached to one end of the conveyor system 30, as shown, where the solid material is distributed onto the road surface.

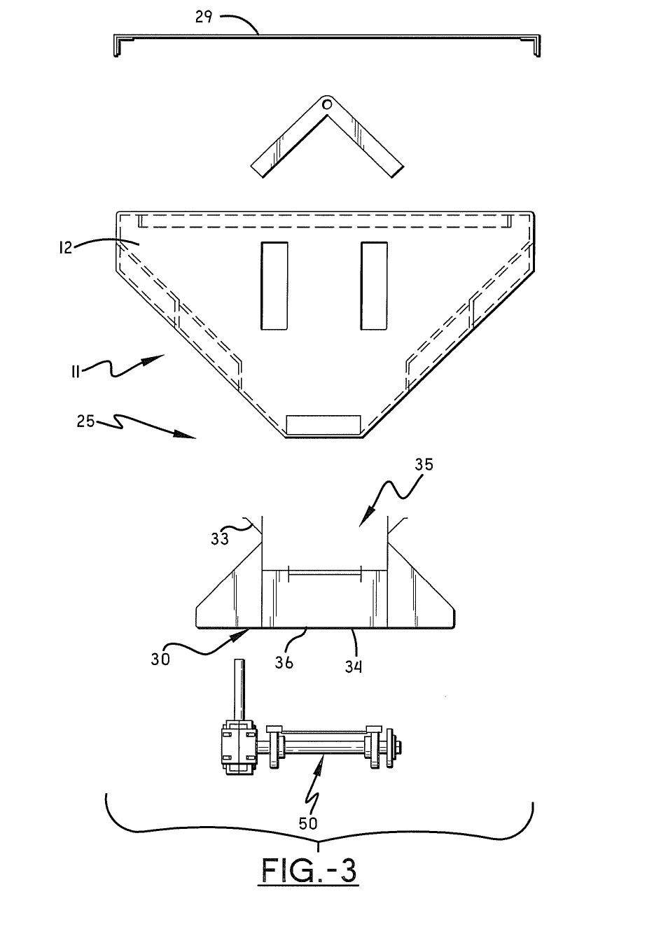

With reference now to FIGS. 2 and 3, as noted above, the conveyor system 30 may include a trough/frame 34 and a conveyor chain and/or belt 32 that operates within the trough 34. Other well known components of a conveyor system, such as sprockets, are also included with the conveyor system 30. In one embodiment, the trough 34 is formed of any steel chosen with sound engineering judgment. In another embodiment, the trough 34 is formed of a non-corrosive metal, such as stainless steel. In still another embodiment, all metal parts of the conveyor system 30 are formed of stainless steel. The trough 34 has an open top 35 that receives the hopper 12 as noted above. Optionally, a screen 29 is positioned on top of the hopper 12 to prevent foreign material from mixing with the salt or sand in the hopper 12. The screen 29 can be attached to the hopper 12 in any conventional way, such as using bolts to hold the screen 29 to the hopper 12. The trough 34 has a bottom 36 that may be closed, as shown. The closed bottom 36 has several advantages. One advantage is that strength is added to the trough 34. Another advantage is that the conveyor chain and/or belt 32 is substantially enclosed. As a result, the material is prevented from spilling out along the truck bed. Still another advantage of the closed bottom 36 is that abrasion to the truck bed is greatly reduced.

With continuing reference to FIGS. 2 and 3, the power unit 40 provides power to operate the conveyor chain and/or belt 32. In one embodiment, shown in FIG. 2, the power unit 40 is a hydraulic unit 42 that operates in a known manner with a conveyor motor 46 to drive the conveyor chain and/or belt 32. In one embodiment, the hydraulic unit 42 is a stand alone unit. In another embodiment, the hydraulic unit 42 is operatively connected to a hydraulic system (not shown) mounted on the vehicle. The conveyor motor 46 may be mounted to a motor mount 48 for installation onto the trough/frame 34, as shown. A cover member 37 may then be attached to the back end of the trough 34, as shown, to protect the conveyor motor 46 and other conveyor components. The hydraulic unit 42 may be mounted to a plate 38 which can be easily installed onto the trough 34, as shown. In another embodiment, not shown, the power unit 40 uses an internal combustion engine that operates in a known manner with a gearbox to drive the conveyor chain and/or belt 32. A shroud 52 may be provided to protect the power unit 40, whether the hydraulic unit 42 or the engine. The shroud 52 may be pivotably connected to the plate 38 so that it can easily be moved (rotated) to provide accessibility to the power unit 40. The shroud 52 may pivot downward in direction A2 about pivot point 53 from a cover position (where the power unit 40 is covered) to an accessible position (where the power unit 40 is accessible, uncovered). The pivot point 53 may be a bolt or pivot pin that pivotably connects the shroud 52 to the plate 38. In one embodiment, the motor mount 48, the cover member 37, the plate 38, and the shroud 52 are all constructed from stainless steel or other non-corrosive material to extend the life of the components.

Still referring to FIGS. 2 and 3, the spinner system 70, as is well known, distributes the material from the conveyor system 30 onto the road surface. An optional spinner extension 72 may be utilized to provide a height adjustment for the spinner system 70. The spinner may be constructed from a non-corrosive material such as stainless steel. However, any non-corrosive material may be used to construct the spinner and associated components as chosen with sound engineering judgment. The particular operation of the spinner system 70 may be conventional and thus will not be described in detail.

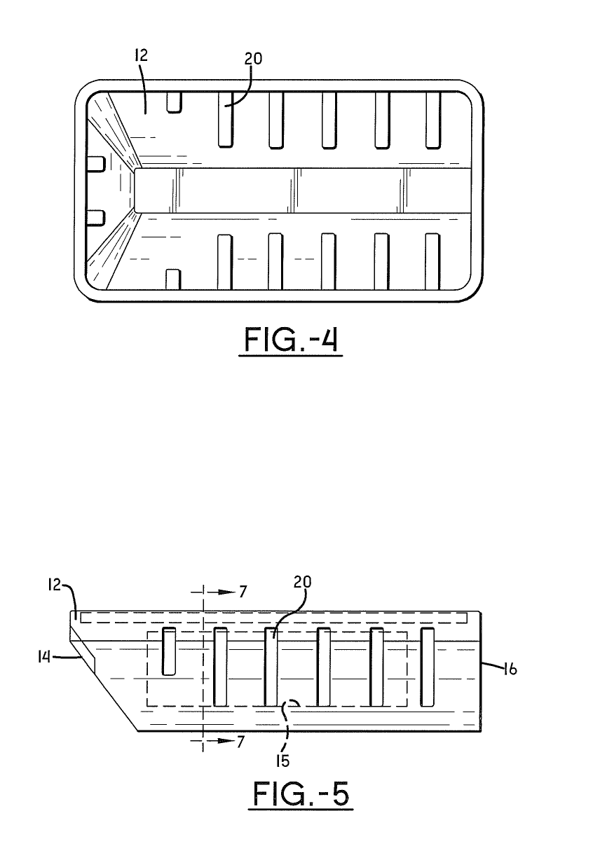

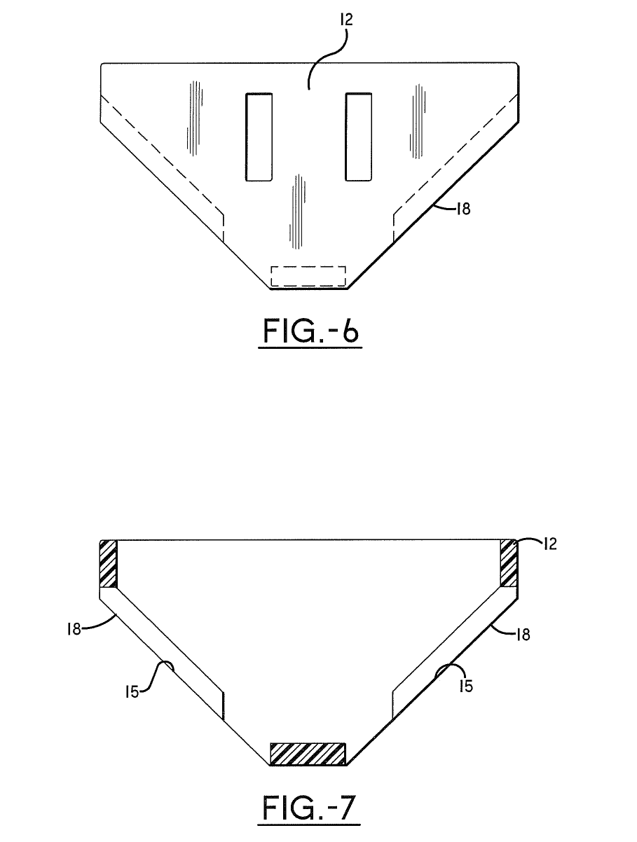

With reference now to FIGS. 2-6, one embodiment hopper assembly 11 will now be described in more detail. An attachment mechanism 25 is used to attach the hopper 12 to the trough 34. In one embodiment, the attachment mechanism 25 includes a number of bolts or screws that hold the hopper 12 to the top portion 33 (shown in FIG. 3) of the trough 34 after the bottom of the hopper 12 has been positioned within the trough 34. The hopper assembly 11 includes the hopper 12 having a front wall 14, a back wall 16, and a pair of side walls 18 extending between the front 12 and rear 14, as shown. The side walls 18 may be angled, as shown, to form a V-shape as seen best in FIG. 5. However, any hopper shape will work well with this invention. The front wall 14 may be angled as shown to fit within the corresponding truck. The side walls 18 and front wall 14 may have one or more ribs 20, extending in a generally vertical orientation, to increase hopper strength. The particular size of the hopper 12 can be any chosen with sound engineering judgment. The hopper 12 may be formed of a plastic material, such as a linear medium density polyethylene. This material provides the advantage of permitting the hopper to be formed in a rotational molding process. Further, this material is lightweight and corrosion resistant, which is beneficial due to the nature of the product it will be carrying and dispensing, namely salt and/or sand. Of course any polymeric material (plastic) may be utilized chosen in accordance with sound engineering judgment.

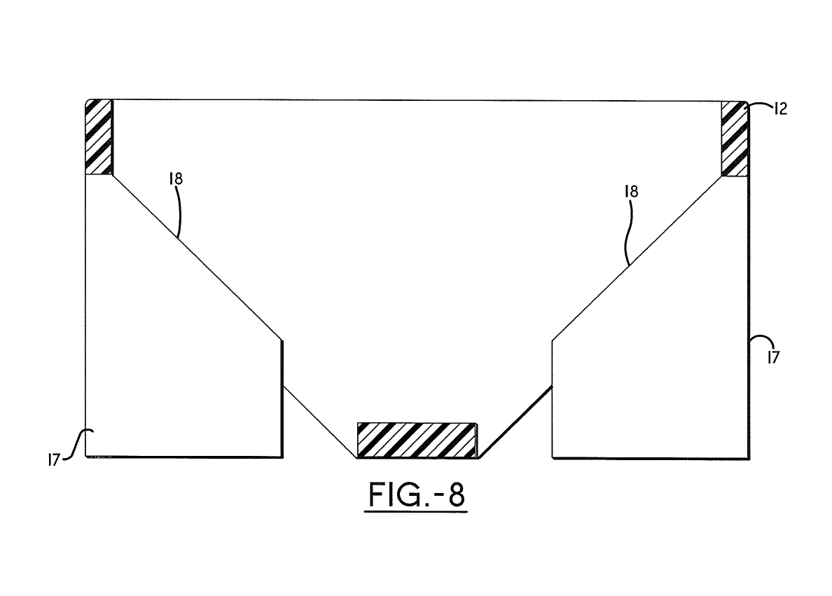

With reference now to FIGS. 1 and 4-7, in one embodiment the hopper 12 has at least one compartment 15, two shown, formed integral with any wall of the hopper 12. By formed integral it is meant that each compartment 15 has at least one surface defined by the hopper wall surfaces. For the embodiment shown in FIG. 7, the compartments 15, 15 are formed within the side walls 18, 18 of the hopper 12. Alternatively, or in addition, compartments may be similarly formed in the front and/or back wall 14, 16. As noted above, each compartment 15 may be used to hold any liquid agent, including pre-wetting liquids, as chosen with sound engineering judgment. The specific size, shape and volume of each compartment 15 may also be any chosen with sound engineering judgment. FIG. 8 shows another embodiment where each compartment 17 extends outward beyond the outer surface of the side wall 18. This provides additional compartment 15 volume without requiring additional truck space when used with a V-shaped hopper, as shown. The bottom surfaces of the compartments may rest on the vehicle bed 2.

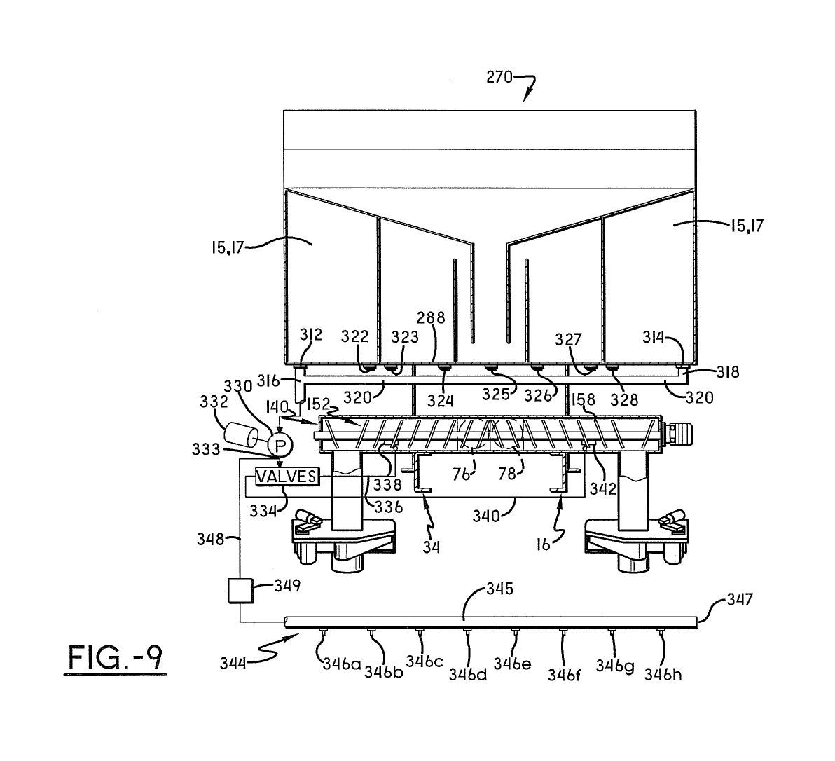

With reference now to FIGS. 1 and 4-9, FIG. 9 is a schematic representation of a liquid spray system 270 that may be used with the compartments 15 or 17. In some cases, improved ice removal performance has been observed when the granular salt material is combined or wetted with a brine solution, for example, calcium chloride brine or sodium chloride brine. Savings in personnel time and cost may be realized by forming this brine solution on the truck 1 itself. Accordingly, a liquid spray system 270 may be supported from the truck 1. The liquid, whether a brine, pre-wetting agent or other liquid, may be stored in the compartments 15 or 17. This liquid is then distributed to the cross transport mechanism 140 for mixing with granular salt or other solid agent. Ports 312 and 314 may be in mutual fluid communication by virtue of a conduit arrangement including pipe 316 extending from port 312 and pipe 318 extending from port 314. These pipes 316 and 318 are joined together in fluid communication by a flexible conduit or hose 320. Access to the compartments additionally may be provided by a sequence of clean-out plugs 322-328 extending through the bottom surface 288. The conduit or pipe 316 may direct liquid from ports 312 and 314 into a pump 330 which is driven by a hydraulic motor 332. The thus pressurized liquid is directed as represented at arrow 333 through a valve function represented at block 334. Valve function 334 performs in conjunction with the operator selection of either or both conveyor chain and/or belt systems 76 and 78. When chain and/or belt system 76 is driven, then as represented by arrow 336, liquid is pumped through an orifice 338 into the chain and/or belt system flight sequence 152. Correspondingly, where the operator causes the actuation of chain and/or belt system 78, then liquid is pumped into the cross chain and/or belt system flight sequence 158 as represented by arrow 340 and orifice 342. Accordingly, advantage is taken of the thorough mixing of the liquid with the solid, using the cross chain and/or belt system flights for this purpose. A spray bar assembly 344 having an elongate pipe 345 having eight fluid outlets 346a-346h and a capped end 347 may be provided. The spray bar assembly 344 receives liquid from the pressure outlet of pump 330 at arrow 333. This liquid under pressure is directed as represented at arrow 348 to the input of pipe 345 and through a sequence valve represented at block 349. Valve 349 is actuated to open when the valve function 334 is in an off condition and the pump 330 is operating to apply liquid under pressure to the conduit represented by arrow 348.

Any manner of controlling the spreader system 10 chosen with sound engineering judgment can be used. One such method is provided in U.S. Pat. No. 5,947,391 titled PRECISION PLACEMENT SPREADER which has a common assignee and which is incorporated herein by reference.

Many embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

1. A spreader system comprising:
a hopper formed substantially of plastic for use in holding solid agents, the hopper having at least a first wall;
a conveyor system formed substantially of non-corrosive metal for use in conveying solid agents, the conveyor system defining a frame, the hopper being attached to the conveyor system;
a spinner system formed substantially of non-corrosive metal for use in distributing solid agents, the spinner system being operatively connected to the conveyor system;
at least a first compartment formed substantially of plastic for use in holding liquid agents, the first compartment formed integral with the first wall; and,
a liquid spray system for use in distributing liquid agents, the liquid spray system being operatively connected to the first compartment.

2. The spreader system of claim 1 wherein the first compartment extends beyond the outer surface of the first wall.

3. The spreader system of claim 1 wherein the hopper is formed of linear medium density polyethylene.

4. The spreader system of claim 1 wherein the conveyor system and the spinner system are formed substantially of stainless steel.

5. The spreader system of claim 1 wherein the hopper has a front wall, a back wall and a pair of side walls, the first compartment being formed integral with one of the side walls, the spreader system further comprising:
a second compartment formed substantially of plastic for use in holding liquid agents, the second compartment formed integral with the other side wall.

6. The spreader system of claim 5 wherein the side walls are angled to form a V-shape.

7. A spreader system comprising:
a V-shaped hopper formed substantially of plastic for use in holding solid agents, the hopper having a front wall, a back wall and first and second side walls;
a conveyor system formed substantially of non-corrosive metal for use in conveying solid agents, the conveyor system defining a frame, the hopper being attached to the conveyor system;
a spinner system formed substantially of non-corrosive metal for use in distributing solid agents, the spinner system being operatively connected to the conveyor system;
first and second compartments formed substantially of plastic for use in holding liquid agents, the first compartment formed integral with the first side wall, the second compartment formed integral with the second side wall; and,
a liquid spray system for use in distributing liquid agents, the liquid spray system being operatively connected to the first and second compartments.

8. The spreader system of claim 7 wherein the first compartment extends beyond an outer surface of the first side wall and the second compartment extends beyond an outer surface of the second side wall.

9. The spreader system of claim 7 wherein the hopper and the first and second compartments are formed of linear medium density polyethylene.

10. The spreader system of claim 9 wherein the hopper and the first and second compartments are formed in a rotational molding process.

11. The spreader system of claim 7 wherein the conveyor system and the spinner system are formed substantially of stainless steel.

12. The spreader system of claim 7 wherein the first and second compartments are for use in holding pre-wetting liquids.

13. The spreader system of claim 7 wherein the first and second side walls each have at least one rib extending in a generally vertical orientation to increase hopper strength.

14. A vehicle comprising:
a vehicle bed; and,
a spreader system comprising:
a V-shaped hopper formed substantially of plastic for use in holding solid agents, the hopper having a front wall, a back wall and first and second side walls;
a conveyor system formed substantially of non-corrosive metal for use in conveying solid agents, the conveyor system defining a frame, the hopper being attached to the conveyor system, the conveyor being supported on the vehicle bed;
a spinner system formed substantially of non-corrosive metal for use in distributing solid agents, the spinner system being operatively connected to the conveyor system;
first and second compartments formed substantially of plastic for use in holding liquid agents, the first compartment formed integral with the first side wall, the second compartment formed integral with the second side wall; and,
a liquid spray system for use in distributing liquid agents, the liquid spray system being operatively connected to the first and second compartments.

15. The vehicle of claim 14 wherein:
the first compartment extends beyond an outer surface of the first side wall and has a bottom surface that at least partially rests on the vehicle bed; and,
the second compartment extends beyond an outer surface of the second side wall and has a bottom surface that at least partially rests on the vehicle bed.

16. The vehicle of claim 14 wherein the hopper and the first and second compartments are formed of linear medium density polyethylene.

17. The vehicle of claim 16 wherein the hopper and the first and second compartments are formed in a rotational molding process.

18. The vehicle of claim 14 wherein the conveyor system and the spinner system are formed substantially of stainless steel.

19. The vehicle of claim 14 wherein the first and second compartments are for use in holding pre-wetting liquids.

20. The vehicle of claim 14 wherein the first and second side walls each have multiple ribs extending in a generally vertical orientation to increase hopper strength.
